(19) United States
(12) Patent Application Publication
(10) Pub. No.: US 2023/0252062 A1
(43) Pub. Date: Aug. 10, 2023

(54) METHOD AND A SYSTEM FOR DISPLAYING A KNOWLEDGE GRAPH

(71) Applicants: Dagnachew Birru, (US); Vishal Vaddina, (US); Somil Shah, (US); Kenneth Rebello, (US)

(72) Inventors: Dagnachew Birru, (US); Vishal Vaddina, (US); Somil Shah, (US); Kenneth Rebello, (US)

(73) Assignee: Quantiphi, Inc, Marlborough, MA (US)

(21) Appl. No.: 18/128,343

(22) Filed: Mar. 30, 2023

(51) Int. Cl. G06F 16/34; G06F 40/205; G06F 40/295

(52) U.S. Cl. CPC G06F 16/34; G06F 40/205; G06F 40/295

(57) ABSTRACT

The disclosure provides a system, a method, and a computer program product for displaying a sentence in a Knowledge Graph at a client device. The method comprises displaying, at the client device, at least an entity in the Knowledge Graph as a node. The method may include displaying, at the client device, at least a relation in the Knowledge Graph as an edge. The method may further include, displaying, at the client device, a sentence on selecting the edge of the Knowledge Graph, wherein the sentence is a natural language expression associated with the relation. The method also allows for visually adjusting the display density of the Knowledge Graph.

### TECHNOLOGICAL FIELD

The present disclosure relates to a Knowledge Graph and more particularly relates to systems and methods for displaying and visually manipulating a Knowledge Graph.

### BACKGROUND

A Knowledge Graph is a type of database that stores information in a way that represents the relationships between different concepts, entities, and data points. It is designed to enable users to better understand the meaning and context behind data, enabling users to make more accurate and informed decisions.

In a Knowledge Graph, data is organized into nodes and edges, where nodes represent entities or concepts, and edges represent the relationships between them. For example, a Knowledge Graph might include nodes for people, places, and things, with edges representing the relationships between them, such as “works at”, “lives in”, or “is a type of”.

There is a preference for alternative navigation paradigm in the medical space especially after the COVID-19 pandemic for such a Knowledge Graph. All the articles, specifically scholarly publications, can be organized as a Knowledge Graph.

Further the Knowledge Graph must provide an easily navigable visual interface. A user with the help of the interface can get an overall picture of the knowledge domain, understand the relationships between concepts and navigate to the right information. And this saves a lot of time and effort for the user. Further, this will be of immense benefit to the scientific community. The overall visualization suite may be detached from the data and used in domains other than scientific as well.

Therefore, there is a need for improved systems and methods for displaying, for example, a sentence, and visually manipulating a Knowledge Graph.

### BRIEF SUMMARY

There is a need for a system and method for displaying and visually manipulating a Knowledge Graph. Example embodiments of the present disclosure provide a system, a method, and a computer program product for implementing a process of displaying a sentence in a Knowledge Graph at a client device.

A system, a computer-implemented method and a computer programmable product are provided for displaying a sentence in a Knowledge Graph at a client device.

Some example embodiments disclosed herein provide a computer-implemented method and computer programmable product for implementing a process of displaying a sentence in a Knowledge Graph at a client device. The method comprises displaying, at the client device, at least an entity in the Knowledge Graph as a node. The method may include displaying, at the client device, at least a relation in the Knowledge Graph as an edge. The method may further include, displaying, at the client device, a sentence on selecting the edge of the Knowledge Graph, wherein the sentence is a natural language expression associated with the relation.

According to some example embodiments, the computer-implemented method further comprising displaying density of nodes wherein the density of nodes to be displayed is adjustable.

According to some example embodiments, the density of the nodes to be displayed is adjusted using a slider interface.

According to some example embodiments, the computer-implemented method further comprising displaying a set of nodes on adjusting the display density wherein the set of nodes is directly proportional to an importance score.

According to some example embodiments, the importance score of the set of nodes depends on at least number of edges connected to the nodes or centrality of the nodes.

According to some example embodiments, the computer-implemented method further comprising selecting the node, wherein on selecting the node, only the node and edges connected to the node and a first set of nodes connected to the edges are displayed.

According to some example embodiments, the computer-implemented method further comprising displaying, a second set of nodes connected to the first set of nodes and a second set of edges, in a distinctive manner from the node, the first set of nodes and the first set of edges.

According to some example embodiments, the computer-implemented method further comprising creating a sub-Knowledge Graph by selecting at least one node from the first set of nodes or the second set of nodes.

According to some example embodiments, the computer-implemented method further comprises an interactive legend wherein the interactive legend is used to mark a node. In addition, on selecting the legend a specific category of nodes may appear or disappear along with associated edges.

According to some example embodiments, the computer-implemented method further comprising extracting from the sentence, a first node, a first edge and a second node, and storing as a triplet the first node, the first edge and the second node.

In one aspect, a system for displaying a sentence in a Knowledge Graph at a client device is disclosed. The system comprises at least a hardware processor and computer executable instructions, that when executed by the hardware processor, cause the system to display a sentence in a Knowledge Graph at a client device. The at least one processor is further configured to displaying, at the client device, at least an entity in the Knowledge Graph as a node. Further, the at- least a processor is configured to displaying, at the client device, at least an entity in the Knowledge Graph as a node. Also, the at least one processor is configured to displaying, at the client device, a sentence on selecting the edge of the Knowledge Graph, wherein the sentence is a natural language expression associated with the relation. Further, selecting the edge of the Knowledge Graph may be achieved by clicking or hovering over the edge.

In yet another aspect, a computer program product comprising a non-transitory computer readable medium having stored thereon computer executable instructions which when executed by at least one processor, cause the processor to carry out operations for displaying a sentence in a Knowledge Graph at a client device.

The operations further comprise displaying, at the client device, at least an entity in the Knowledge Graph as a node.

The operations further comprise displaying, at the client device, at least a relation in the Knowledge Graph as an edge.

The operations further comprise displaying, at the client device, a sentence on selecting the edge of the Knowledge Graph, wherein the sentence is a natural language expression associated with the relation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a display of a sentence associated with a relation, in accordance with an example embodiment;

FIG. 2 illustrates a visual rendering of a Knowledge Graph with an adjustable slide, in accordance with an example embodiment;

FIG. 3 illustrates a display of a Knowledge Graph after the slide has been adjusted, in accordance with an example embodiment;

FIG. 4 illustrates a display of a Knowledge Graph after selecting a node, in accordance with an example embodiment;

FIG. 5 shows a flow diagram of a method for displaying a sentence in a Knowledge Graph at a client device, in accordance with an example embodiment;

FIG. 6 shows a flow diagram of a method for creating a subgraph, in accordance with an example embodiment;

FIG. 7 shows a flow diagram of a method for adjusting the displaying density of the nodes in accordance with an example embodiment;

FIG. 8 illustrates a block diagram of an electronic circuitry for displaying a Knowledge Graph, in accordance with an example embodiment;

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

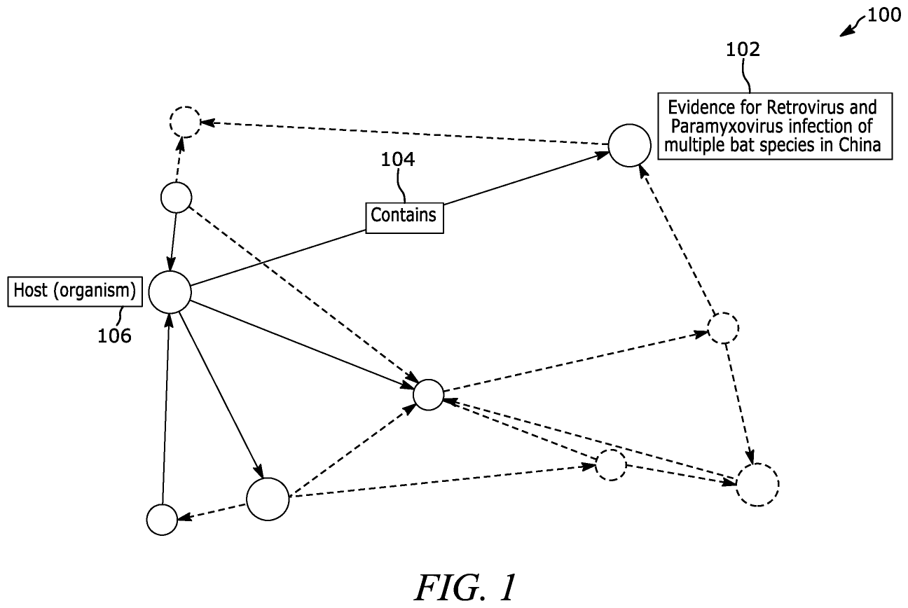

FIG. 1 illustrates a display of a sentence associated with a relation, in accordance with an example embodiment. In FIG. 1 first node 102 and a second node 106. are connected by an edge 104. In an example embodiment a user may be enabled to select either node 102, node 106 or edge 104 of a Knowledge Graph. In case the user selects the edge 104 of a Knowledge Graph a sentence is displayed. The sentence is the natural language expression of the selected edge. In an example embodiment, second node 106 corresponds to “Host (organism)” entity, the edge 104 corresponds to the text “contains”, the first node 102 corresponds to the text “Evidence for Retrovirus and Paramyxovirus Infection of Multiple Bat Species in China”. Therefore, when a user selects the edge 104 an entire sentence “Host (organism) contains Evidence for Retrovirus and Paramyxovirus Infection of Multiple Bat Species in China” is displayed.

The Knowledge Graph is a type of graph database that is designed to store and represent knowledge in a structured and organized way. An Entity-Relation model is used for a Knowledge Graph. Thereby, it is a collection of entities, which can be anything from people and places to concepts and ideas, and the relationships between those entities. Further, Knowledge Graphs are used to power search engines, chatbots, recommendation systems, and other applications that require intelligent information retrieval and processing.

At the heart of a Knowledge Graph is a set of nodes, each representing an entity, and a set of edges, each representing a relationship between entities. Nodes can have attributes such as labels, descriptions, and types that provide additional information about the entity they represent. Edges can also have attributes that describe the relationship between the entities they connect.

One of the defining characteristics of a Knowledge Graph is its ability to model complex relationships between entities. In an example embodiment, a Knowledge Graph could represent the relationship between a drug, its formula, and the target disease. The drug node would be connected to a formula node by a “represented by” edge. Further, the drug node would be connected to the disease node by a “targets” edge. By representing relationships in this way, a Knowledge Graph can capture the nuances of real-world knowledge in a structured and easily accessible form.

Another key feature of a Knowledge Graph is its ability to be extended and updated as new information becomes available. Nodes and edges can be added or modified as needed, allowing the Knowledge Graph to evolve over time and adapt to changing requirements. This makes Knowledge Graphs particularly useful for applications that require up-to-date information, such as scientific or real-time search.

In an example embodiment, due to the COVID-19 pandemic, many leading research groups have come together to create the COVID-19 Open Research Dataset (CORD-19). CORD-19 is a resource of over a million scholarly articles, including over 400,000 with full text, about COVID-19, SARS-CoV-2, and related coronaviruses. This open-source data-set is available to the global research community to experiment with and apply recent advances in natural language processing and other Artificial Intelligence (AI) techniques. Further, the open-source dataset is used to create a Knowledge Graph.

Creating a Knowledge Graph for such a large corpus of scientific literature involves several steps which are described below.

A first step is to collect scientific literature data from various sources such as academic databases, digital libraries, or repositories. This data can include research papers, patents, reports, and conference proceedings. In an example embodiment the knowledge source is the scholarly articles about COVID-19 and variants.

The next step is to extract relevant information from the collected data. This can be done using natural language processing (NLP) techniques such as named entity recognition, relation extraction, and topic modelling. The said techniques are used to identify entities such as authors, organizations, locations, and scientific concepts. Relation extraction is used to identify the relationships between entities, such as co-authorship, citation, association or funding etc. Topic modelling is used to identify the main topics and themes of the literature.

Once the relevant information is extracted, it needs to be integrated into a Knowledge Graph. In an example embodiment, graph data is generated by the CORD Knowledge Graph Machine Learning (ML) models, in the form of nodes & edges or in the form of triplets (consisting of a subject, object and relation). This data is curated into a suitable format for the graph library which is used to render the graph for use in the application.

Knowledge Graphs, such as, but not limited to, Document Knowledge Graph, Document-to-Document Knowledge Graph, Comprehensive Knowledge Graph may be created as mentioned below.

In an example embodiment, a Document Knowledge Graph is generated. This graph consists of all the entities within a document, color coded by their subtypes. Every entity is connected to one or more other entities, forming triplets which correspond to sentences sourced from the documents. These triplets are formed by the triplet extractors in the CORD ML systems. Every triplet consists of a subject, object (nodes) and relation (edge).

In a second example embodiment a Document-to-Document Knowledge Graph is generated. This graph displays all the metadata concerning a particular document. It comprises the document's authors, the journals it was published in, the year of publishing and certain significant entities that were present in the document. It further adds other documents that might have any of the above-mentioned details in common with the selected document. Documents suggested for further reading are highlighted in a different color while rendering.

In a third example embodiment Comprehensive Knowledge Graph may be generated. This graph represents the entire dataset comprising of all the research papers. Nodes are made up of documents along with their authors and entities mentioned within them. To add another layer of abstraction, each entity is connected to a concept node which represents the subtype of the entity. This in turn is connected to concept type nodes which represent the type that the subtype belongs to. Like the Document Knowledge Graph, entities are connected to each other to form sentence triplets. Documents are connected by references, while authors are connected by collaborations.

The Knowledge Graph needs to be validated to ensure that the extracted information is accurate and complete. This can be done using manual or automated methods, such as expert review or data quality checks.

In summary, creating a Knowledge Graph for scientific literature requires a combination of human expertise and advanced technologies. It may provide valuable insights and facilitate the discovery of new scientific knowledge.

Further, the Knowledge Graph needs to be visualized to make it accessible and understandable for end-users. This can be done using various visualization techniques, such as network graphs, heat maps, or semantic maps.

Although any of the mentioned visualization techniques may be used, in an example embodiment we use network graphs.

A visualization of a Knowledge Graph using a network graph is a graphical representation of the relationships between entities in the graph. A network graph is a type of visualization that displays the nodes and edges of a graph as points and lines, respectively.

In a Knowledge Graph, the nodes represent entities, while the edges represent the relationships between these entities. Further, to create a network graph visualization of a Knowledge Graph, the nodes and edges are typically represented as circles and lines, respectively. The circles may be sized and colored based on their attributes, such as the number of connections they have or the type of entity they represent. The lines may also be colored and labelled based on the type of relationship they represent.

The network graph visualization can be interactive, allowing users to zoom in and out, hover over nodes to see their attributes, and filter the graph based on various criteria. This can make it easier to explore and analyze the Knowledge Graph and identify patterns and insights.

Overall, a visualization of a Knowledge Graph using a network graph can be a powerful tool for communicating complex information and facilitating data-driven decision-making.

Further, visualization of a Knowledge Graph is realized on a client device. A client device is any electronic device or hardware that connects to a network or server to access resources, data, or services. Some common examples of client devices include but are not limited to desktops computer, laptops, smartphones, tablets, gaming consoles, smart TVs and projection systems.

A user may use several techniques to interact with the visualization. Some of the techniques which are used and are not limited to are mentioned below.

In an example embodiment, one way to visually explore a network graph is to highlight specific nodes or edges based on certain criteria, such as their degree centrality, betweenness centrality, or community membership. This may help to identify the most important or influential nodes and edges in the graph.

In a second example embodiment a network graph is explored by filtering the nodes and edges based on specific criteria, such as their type, attribute values, or connectivity. This may help to focus on specific subsets of the graph and reveal patterns and insights that might be hidden in the overall structure.

In a third example embodiment, an interactive visualization can enable users to explore the network graph in real-time, by allowing them to zoom in and out, pan, and select nodes and edges. This can make it easier to identify patterns and relationships in the graph and to generate insights.

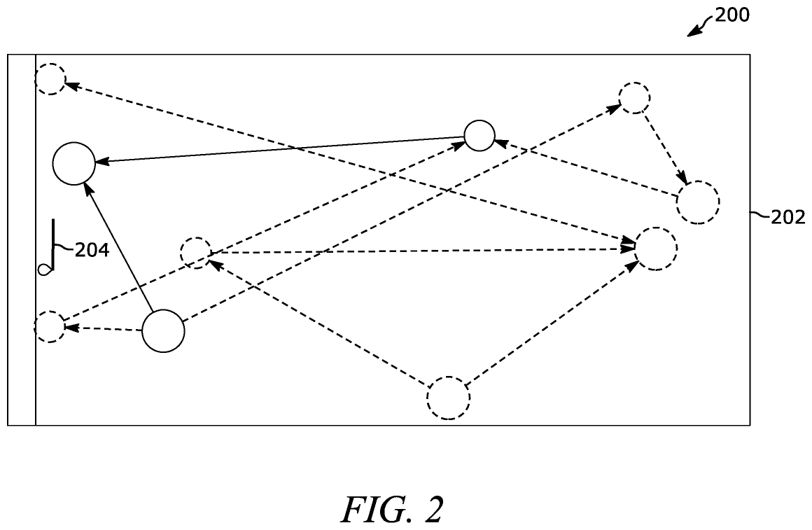

FIG. 2 illustrates a visual rendering of a Knowledge Graph 202 with an adjustable slider 204, in accordance with an example embodiment. The Knowledge Graph 202 and a slider 204 may be displayed alongside. In an example embodiment, the slider 204 may be used to adjust the display density of the Knowledge Graph 202.

The slider 204 is used to adjust the density of display of the Knowledge Graph. In other example embodiments the slider can be replaced with other GUI widgets.

There are several alternatives to a slider in a GUI (Graphical User Interface) that can be used to provide users with a way to input values or make selections. Some of these alternatives include but are not limited to the GUI mentioned below.

A spin box is a GUI widget that allows users to increment or decrement a numerical value by clicking arrow buttons.

A Dropdown list is a GUI widget that displays a list of options for the user to select from. The selected option is displayed in the widget's text field.

A text field is a GUI widget that allows users to directly input numerical values or other data using the keyboard. This is a flexible and precise option for inputting numerical data.

Radio buttons are a group of GUI widgets that allow users to select only one option from a group of options. Each radio button represents a different option, and the user can only select one.

In an alternate embodiment, touchscreen gestures are used in lieu of a slider. On touch screen devices, users may use swipe or pinch gestures to input numerical values or make selections.

In accordance with an embodiment, the display density of the Knowledge Graph 202 may be the number of nodes displayed per unit area of a display device. Further, the unit area may be in terms of square cm, inches or any other standard measure known to a person having skill in the area. Also, the unit area can be expressed as display pixels, for example 8×8 pixels.

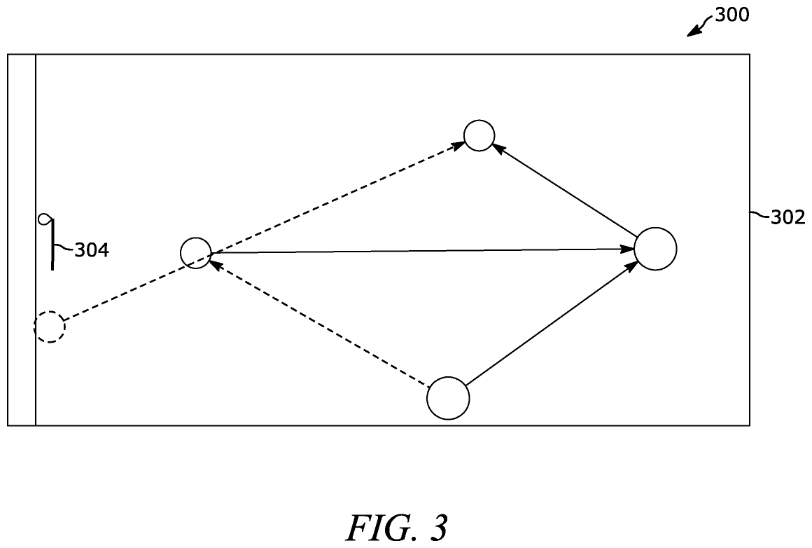

FIG. 3 illustrates a Knowledge Graph 302 displayed after the slider 304 has been adjusted upwards. In an embodiment, certain nodes may be made visible and other nodes may not be displayed on adjusting the slider 304 upwards. In accordance with an embodiment, the nodes displayed on upward adjustment are the nodes that are of importance.

In an example embodiment, the nodes that are central are considered important.

The centrality of a node in a graph refers to the importance or influence of that node in the overall structure of the graph. Centrality measures aim to quantify the extent to which a node is central, or in other words, how much it affects the graph's connectivity or flow.

There are several ways to define centrality of a node in a graph, and the choice of measure depends on the specific context and application. Some common centrality measures are mentioned below but is not limiting.

Degree centrality counts the number of edges incident to a node, i.e., the number of direct connections it has with other nodes. Nodes with high degree centrality are typically well-connected and serve as hubs in the network.

Betweenness centrality quantifies the extent to which a node lies on the shortest paths between other nodes. Nodes with high betweenness centrality play an important role in connecting different parts of the graph and facilitating communication and flow.

Closeness centrality calculates the inverse of the sum of the shortest path distances between a node and all other nodes in the graph. Nodes with high closeness centrality are close to many other nodes and can quickly transmit information or influence across the graph.

Eigenvector centrality takes into account the centrality of a node's neighbors and assigns higher centrality scores to nodes that are connected to other central nodes. Nodes with high eigenvector centrality are influential because they are connected to other important nodes.

In summary, centrality measures provide a way to quantify the importance of nodes in a graph, and they can help identify key players or bottlenecks in various types of networks, including social networks, transportation networks, and biological networks. In an example embodiment in the Knowledge Graph degree centrality may be used.

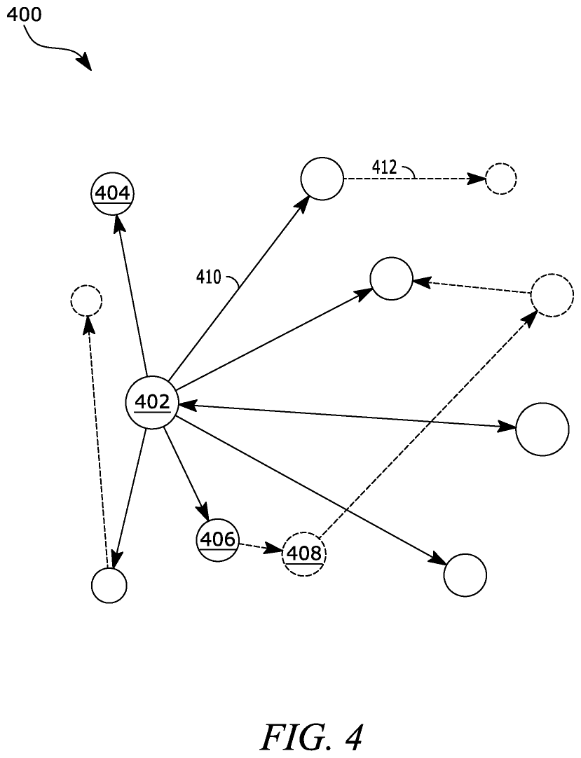

FIG. 4 illustrates a display of the Knowledge Graph after selecting a node 402 in accordance with an example embodiment. The node 402 is the selected node. The nodes 404 and 406 are immediate neighbors as they are connected directly to 402 via an edge. First-degree connections is a term used to refer to the immediate neighbors. The node 408 is connected to 406 which implies that 402 is indirectly connected to 408 via 402. These nodes such as 408 are termed the second-degree connections to 402. Further an edge 410 is also connected.

In accordance with an embodiment, a node 402 may be selected. In another embodiment the selection of the node 402 may be performed by clicking on the node 402. Further, selection of the node 402 highlights the node 402 and its connected nodes and edges. For example, 404 and 406 in the Knowledge Graph which are first-degree connections of node 402 are highlighted, while other elements are hidden.

The connected entities may have further connections, termed as second-degree connections, for example 408 with respect to the selected element. These second-degree connections are highlighted in a manner distinct from the first-degree connections.

In accordance with an embodiment the distinct manner may be the second-degree connections may be of a lighter shade compared to the first-degree connections.

Further, the second-degree nodes may be highlighted manually, by clicking on any already highlighted element that they are connected to. This may convert the second-degree connections into normal connections and add more connections to the graph.

In this way a subgraph may be built of elements that are of interest, making it more convenient for exploration.

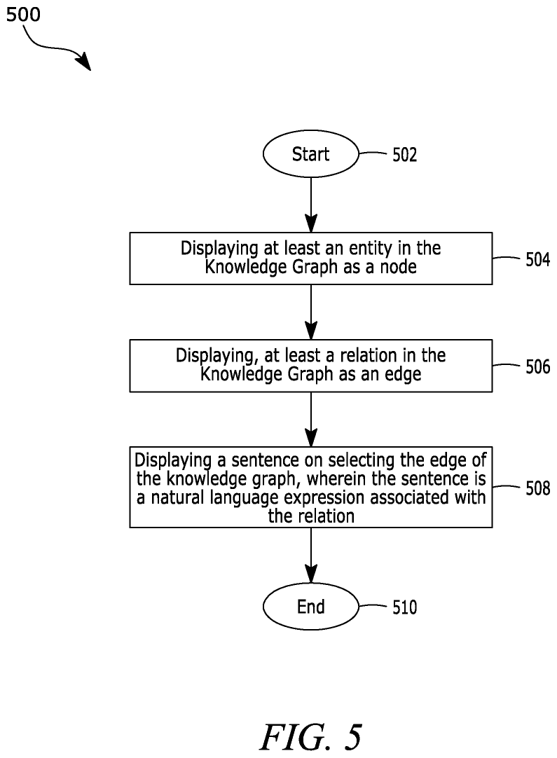

FIG. 5 illustrates a flow diagram of a method 500 for displaying a sentence in a Knowledge Graph, in accordance with an example embodiment. It will be understood that each block of the flow diagram of the method 500 may be implemented by various means, such as hardware, firmware, processor, circuitry, and/or other communication devices associated with execution of software including one or more computer program instructions 824. For example, one or more of the procedures described above may be embodied by computer program instructions 824. In this regard, the computer program instructions which embody the procedures described above may be stored by a memory 804 of the system 800, employing an embodiment of the present invention and executed by a processor 802. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 500 illustrated by the flowchart diagram of FIG. 5 is displaying a sentence in a Knowledge Graph. Fewer, more, or different steps may be provided.

The method flow diagram 500 starts at step 502. At step 504, the method 500 comprises displaying, at the client device, at least an entity in the Knowledge Graph as a node. In an example embodiment the entity may refer to a subject or object. The subject, for example, “Covishield”, the object, for example “Coronavirus” and the relation node is “prevents”. Therefore, when the edge “prevents” is selected then the sentence “Covishield prevents coronavirus” is displayed.

At step 506, the method 500 comprises displaying, at the client device, at least a relation in the Knowledge Graph as an edge. In an example embodiment, the relation may be of different types, such as but not limited to “is a”, “part of”, “located in”, “causes”, “belongs to”, “has”, etc. The edge of the Knowledge Graph may be the relation of an Entity-Relation model.

The modelling of a Knowledge Graph as an entity relationship involves the below mentioned steps.

Define the entities by identifying the entities that will be part of the Knowledge Graph. Entities can be anything from people, places, and things to abstract concepts, events, and processes.

Define the relationships by identifying the relationships that exist between the entities. Relationships may be of different types, such as but not limited to “is a”, “part of”, “located in”, “causes”, “belongs to”, “has”, etc.

Define the properties by identifying the properties that describe the entities and relationships. Properties are the attributes or characteristics of an entity or relationship, such as the name, type, description, date, location, etc.

Creating a schema that defines the entities, relationships, and properties, and how they are related to each other. The schema serves as a blueprint for the Knowledge Graph and ensures consistency and coherence in the data.

The final step is populating the Knowledge Graph with data by adding nodes for the entities, edges for the relationships, and attributes for the properties.

In an example embodiment, the Knowledge Graph may be visually explored through the displayed nodes and edges.

Optionally a query language may be used to query the Knowledge Graph and retrieve the information needed. Queries can be simple or complex and can involve multiple entities and relationships.

At step 508, the method 500 comprises displaying, at the client device, a sentence on selecting the edge of the Knowledge Graph, wherein the sentence is a natural language expression associated with the relation. In an example embodiment, on selecting the edge of the Knowledge Graph an excerpt may be displayed.

Extracting an Entity Relation model from natural language involves identifying the relevant entities and their relationships within the text. Mentioned below are some general steps that can be followed to accomplish this in an example embodiment.

The initial step is to identify the relevant entities in the text. Entities can be anything from people, places, organizations, products, to events or concepts. These entities can be identified using Named Entity Recognition techniques, which are commonly used in natural language processing.

After identifying entities, the next step is to determine the relationships between them. Relationships can be of different types such as temporal, spatial, causal, or semantic. These relationships can be inferred from the text by analyzing the verbs, prepositions, and other connecting words.

Once the entities and relationships have been identified, create a graph that represents the Entity Relation model. Each entity can be represented as a node, and each relationship can be represented as a directed edge connecting two nodes.

Finally, refine the Entity Relation model by checking for consistency, completeness, and accuracy. Ensure that all the relevant entities and relationships have been included in the model, and that the relationships are correctly represented.

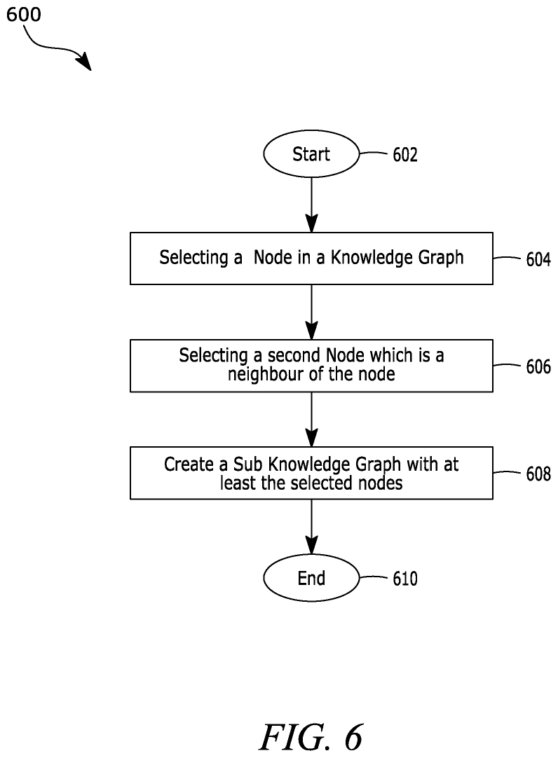

FIG. 6 illustrates a flow diagram for creating a subgraph in accordance with an example embodiment. It will be understood that each block of the flow diagram of the method 500 may be implemented by various means, such as hardware, firmware, processor, circuitry, and/or other communication devices associated with execution of software including one or more computer program instructions 824. For example, one or more of the procedures described above may be embodied by computer program instructions 824. In this regard, the computer program instructions which embody the procedures described above may be stored by a memory 804 of the system 800, employing an embodiment of the present invention and executed by a processor 802. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks. Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600illustrated by the flowchart diagram of FIG. 6 is creating a subgraph. Fewer, more, or different steps may be provided.

The method 600 starts at step 602. At step 604, the method 600 comprises selecting a node in a Knowledge Graph. The node may be selected by a user, in a Knowledge Graph. In an example embodiment, on selecting the node, all immediate neighboring nodes that are connected to the selected node by a single edge are displayed. The immediate neighbors of the node are also termed as first-degree connections.

The nodes that are connected to the first-degree connections are termed second-degree connections.

At step 606, the method 600 comprises selecting a second node which is a neighbor of the selected node. The neighbor of the selected node may be a first-degree or second-degree connections, The second node may be selected by a user from among the first-degree or the second-degree connections. Further, the user may select multiple nodes.

At step 608, the method 600 comprises creating a sub-Knowledge Graph with at least the selected nodes. In an example embodiment, a user may select a node and certain nodes which are either first-degree or second-degree connections of the selected node. Using the selected nodes, the user may build and display a sub Knowledge Graph.

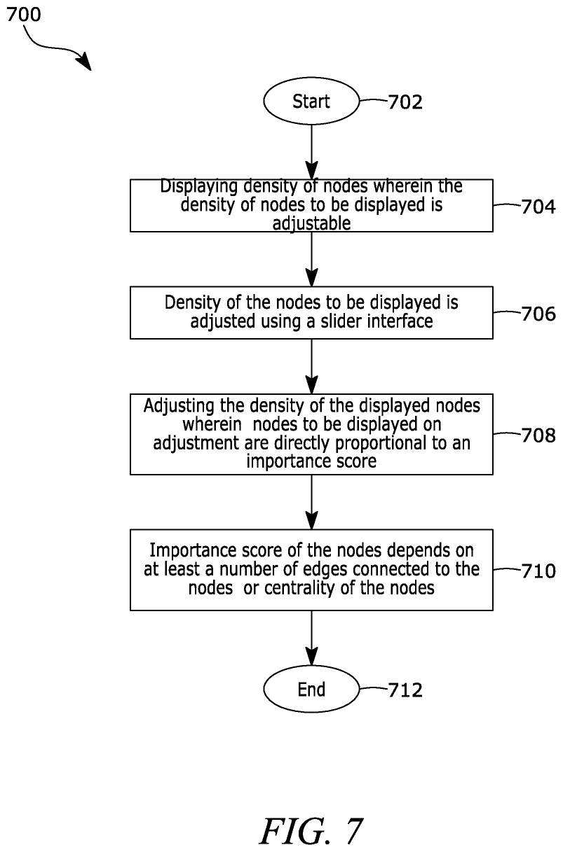

FIG. 7 illustrates a flow diagram of a method 700 for adjusting the display density of nodes, in accordance with an example embodiment. It will be understood that each block of the flow diagram of the method 700 may be implemented by various means, such as hardware, firmware, processor, circuitry, and/or other communication devices associated with execution of software including one or more computer program instructions 824. For example, one or more of the procedures described above may be embodied by computer program instructions 824. In this regard, the computer program instructions which embody the procedures described above may be stored by a memory 804 of the system 800, employing an embodiment of the present invention and executed by a processor 802. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 700 illustrated by the flowchart diagram of FIG. 7 is adjusting the display density of nodes. Fewer, more, or different steps may be provided.

The method 700 starts at step 702. At step 704, the method 700 comprises displaying density of nodes wherein the density of nodes to be displayed is adjustable. In an embodiment the display density of the Knowledge Graph may be the number of nodes displayed per unit area of a display device. Further, the unit area may be in terms of square cm, inches or any other standard measure known to a person having skill in the area. Also, the unit area can be expressed as display pixels, for example 8×8 pixels.

At step 706 a slider interface is used to adjust the density of display of the Knowledge Graph. In other embodiments, the slider can be replaced with other GUI widgets.

There are several alternatives to a slider in a GUI (Graphical User Interface) that can be used to provide users with a way to input values or make selections. Some of these alternatives include but are not limited to the GUI mentioned below.

A spin box is a GUI widget that allows users to increment or decrement a numerical value by clicking arrow buttons.

A Dropdown list is a GUI widget that displays a list of options for the user to select from. The selected option is displayed in the widget's text field.

A text field is a GUI widget that allows users to directly input numerical values or other data using the keyboard. This is a flexible and precise option for inputting numerical data.

Radio buttons are a group of GUI widgets that allow users to select only one option from a group of options. Each radio button represents a different option, and the user can only select one.

In an alternate embodiment, touchscreen gestures are used in lieu of a slider. On touch screen devices, users can use swipe or pinch gestures to input numerical values or make selections.

At step 708 on adjusting the density of display, nodes that are displayed are directly proportional to an importance score.

Finally at step 710 the importance score depends upon the centrality of the nodes.

The centrality of a node in a graph refers to the importance or influence of that node in the overall structure of the graph. Centrality measures aim to quantify the extent to which a node is central, or in other words, how much it affects the graph's connectivity or flow.

There are several ways to define centrality of a node in a graph, and the choice of measure depends on the specific context and application. Some common centrality measures are mentioned below.

Degree centrality counts the number of edges incident to a node, i.e., the number of direct connections it has with other nodes. Nodes with high degree centrality are typically well-connected and serve as hubs in the network.

Betweenness centrality quantifies the extent to which a node lies on the shortest paths between other nodes. Nodes with high betweenness centrality play an important role in connecting different parts of the graph and facilitating communication and flow.

Closeness centrality calculates the inverse of the sum of the shortest path distances between a node and all other nodes in the graph. Nodes with high closeness centrality are close to many other nodes and can quickly transmit information or influence across the graph.

Eigenvector centrality takes into account the centrality of a node's neighbors and assigns higher centrality scores to nodes that are connected to other central nodes. Nodes with high eigenvector centrality are influential because they are connected to other important nodes.

In summary, centrality measures provide a way to quantify the importance of nodes in a graph, and they can help identify key players or bottlenecks in various types of networks, including social networks, transportation networks, and biological networks. In an example embodiment in the Knowledge Graph degree centrality may be used alone or in combination with other centrality measures.

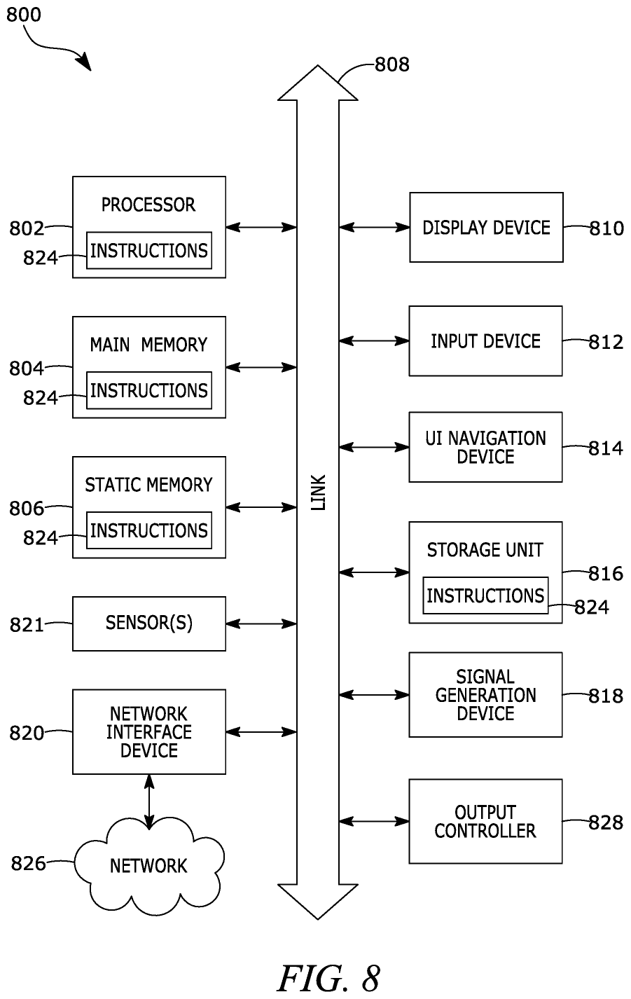

FIG. 8 illustrates a representative machine architecture suitable for implementing the systems and so forth or for executing the methods disclosed herein. The machine of FIG. 8 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 8 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 800 includes at least one processor 802 (e.g., a central processing unit (CPU), a graphics processing unit (GPU), advanced processing unit (APU), or combinations thereof), one or more memories such as a main memory 804, a static memory 806, or other types of memory, which communicate with each other via link 808. Link 808 may be a bus or other type of connection channel. The machine 800 may include further optional aspects such as a graphics display unit 810 comprising any type of display. The machine 800 may also include other optional aspects such as an alphanumeric input device 812 (e.g., a keyboard, touch screen, and so forth), a user interface (UI) navigation device 814 (e.g., a mouse, trackball, touch device, and so forth), a storage unit 816 (e.g., disk drive or other storage device(s)), a signal generation device 818 (e.g., a speaker), sensor(s) 821 (e.g., global positioning sensor, accelerometer(s), microphone(s), camera(s), and so forth), output controller 828 (e.g., wired or wireless connection to connect and/or communicate with one or more other devices such as a universal serial bus (USB), near field communication (NFC), infrared (IR), serial/parallel bus, etc.), and a network interface device 820 (e.g., wired and/or wireless) to connect to and/or communicate over one or more networks 826.

### Executable Instructions and Machine-Storage Medium

The various memories (i.e., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

### Signal Medium

The term “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, el all) etc.).

As used herein, the term “computing device” may refer to a mobile phone, a personal digital assistance (PDA), a tablet, a laptop, a computer, VR Headset, Smart Glasses, projector, or any such device capable of rendering the Knowledge Graph.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

We claim:

1. A computer-implemented method for displaying a sentence in a Knowledge Graph at a client device comprising:
displaying, at the client device, at least an entity in the Knowledge Graph as a node;
displaying, at the client device, at least a relation in the Knowledge Graph as an edge; and
displaying, at the client device, a sentence on selecting the edge of the Knowledge Graph, wherein the sentence is a natural language expression associated with the relation.

2. The computer-implemented method of claim 1, further comprising displaying density of nodes wherein the density of nodes to be displayed is adjustable.

3. The computer-implemented method of claim 2, wherein the density of the nodes to be displayed is adjusted using a slider interface.

4. The computer-implemented method of claim 2, further comprising displaying a set of nodes on adjusting the display density wherein the set of nodes is directly proportional to an importance score.

5. The computer-implemented method of claim 4, wherein the importance score of the set of nodes depends on at least number of edges connected to the nodes or centrality of the nodes.

6. The computer-implemented method of claim 1, further comprising selecting the node, wherein on selecting the node, only the node and edges connected to the node and a first set of nodes connected to the edges are displayed.

7. The computer-implemented method of claim 6, further comprising displaying, a second set of nodes connected to the first set of nodes and a second set of edges, in a distinctive manner from the node, the first set of nodes and the first set of edges.

8. The computer-implemented method of claim 7, further comprising creating a sub-Knowledge Graph by selecting at least one node from a group comprising the first set of nodes and the second set of nodes.

9. The computer-implemented method of claim 1, further comprises an interactive legend wherein the interactive legend is used to mark a node.

10. The computer-implemented method of claim 1, further comprising extracting from the sentence, a first node, a first edge and a second node, and storing as a triplet the first node, the first edge and the second node.

11. A system comprising at least a processor and computer executable instructions, that when executed by the hardware processor, cause the system to display a sentence in a Knowledge Graph at a client device comprising:
displaying, at the client device, at least an entity in the Knowledge Graph as a node;
displaying, at the client device, at least a relation in the Knowledge Graph as an edge; and;
displaying, at the client device, a sentence on selecting the edge of the Knowledge Graph, wherein the sentence is a natural language expression associated with the relation.

12. The system of claim 11, further comprising displaying density of nodes wherein the density of nodes to be displayed is adjustable.

13. The system of claim 12, wherein the density of the nodes to be displayed is adjusted using a slider interface.

14. The system of claim 12, further comprising displaying a set of nodes on adjusting the display density wherein the set of nodes is directly proportional to an importance score.

15. The system of claim 14, wherein the importance score of the nodes depends on at least number of edges connected to the nodes or centrality of the nodes.

16. The system of claim 11, further comprising selecting the node, wherein on selecting the node, only the node and edges connected to the node and a first set of nodes connected to the edges are displayed.

17. The system of claim 16, wherein displaying, a second set of nodes connected to the first set of nodes and a second set of edges, in a distinctive manner from the node, the first set of nodes and the first set of edges.

18. The system of claim 17, further comprising creating a sub-Knowledge Graph by selecting at least one node from a group comprising the first set of nodes andthe second set of nodes.

19. The system of claim 11, further comprising extracting from the sentence, a first node, a first edge and a second node, and storing as a triplet the first node, the first edge and the second node

20. A computer programmable product comprising a non-transitory computer readable medium having stored thereon computer executable instruction which when executed by one or more processors, cause the one or more processors to carry out operations for displaying a sentence in a Knowledge Graph at a client device, the operations comprising:
displaying, at the client device, at least an entity in the Knowledge Graph as a node;
displaying, at the client device, at least a relation in the Knowledge Graph as an edge; and;
displaying, at the client device, a sentence on selecting the edge of the Knowledge Graph, wherein the sentence is a natural language expression associated with the relation.
